(19) United States
(12) Patent Application Publication
(10) Pub. No.: US 2013/0201593 A1
(43) Pub. Date: Aug. 8, 2013

(54) REMOTE CONTROL POWER ISOLATION SWITCH

(71) Applicant: Today's Energy Tomorrow's Future Pty Ltd., Condobolin (NSW) (AU)

(72) Inventor: Daniel Phillip O'Dwyer, Condobolin (NSW) (AU)

(73) Assignee: TODAY'S ENERGY TOMORROW'S FUTURE PTY LTD., Condobolin (NSW) (AU)

(21) Appl. No.: 13/774,161

(22) Filed: Feb. 22, 2013

Related U.S. Application Data
(63) Continuation-in-part of application No. PCT/AU2011/001076, filed on Aug. 23, 2011.

(30) Foreign Application Priority Data
Aug. 23, 2010 (AU) 2010903772

(51) Int. Cl. H01H 47/22

(52) U.S. Cl. CPC H01H 47/22
USPC 361/182

(57) ABSTRACT

A remote control power isolation switch including: an isolation circuit having: a conditioned power supply (CPS) powered from an incoming power; a receiver powered by the CPS and a reception antenna connected thereto; a toggling circuit powered by the CPS and connected to the receiver; and a relay powered by the CPS and operable between “on” and “off” by electrical connection to the toggling circuit; and a remote control circuit having: a portable power supply (PPS); a momentary contact switch operable to connect the PPS to a programmable integrated circuit (PIC); a transmitter powered by the PPS for transmitting a signal matched to the receiver; an electrical connection between the PIC and the transmitter for controlling the transmitter by the PIC; the relay having contacts which connect the incoming power to an outgoing power when “off” and disconnecting the incoming power from the outgoing power when “on”.

### CROSS REFERENCE TO RELATED APPLICATIONS

This application is a bypass continuation-in-part of International Application No. PCT/AU2011/001076, filed Aug. 23, 2011, which claims priority to Australian Provisional Patent Application No. 2010903772, filed Aug. 23, 2010. Both applications are incorporated by reference herein in their entirety.

### FIELD OF INVENTION

This invention relates to a remote control power isolation switch. The invention has particular application to general purpose outlets (power points) in domestic, commercial and industrial power supplies. However, the invention is not limited to this field of use.

### BACKGROUND ART

Electrical appliances often draw current even though they are switched off, especially when they have remote control devices. The current drawn can sometimes be quite high, especially if the switched-off state is really a standby state. It has long been recommended that to save on power consumption, and the cost associated with wastage of electrical power, that appliances are switched off at the wall, where they are connected into the power supply by way of a general purpose outlet (hereinafter referred to as a power point). However, it can be inconvenient to switch power points off. Moreover, sometimes the power point is located behind heavy furniture, making it impossible, or at least impractical, to turn the power point off

The present invention aims to provide a remote control general purpose outlet isolation switch which alleviates one or more of the problems of the prior art. Other aims and advantages of the invention may become apparent from the following description.

### DISCLOSURE OF THE INVENTION

With the foregoing in view, this invention in one aspect resides broadly a remote control power isolation switch including:

an isolation circuit operatively interposed in an incoming power supply to be remotely switched, the isolation circuit having:
a conditioned power supply powered from the incoming power supply;
a radio frequency receiver powered by the conditioned power supply and having a radio frequency reception antenna electrically connected thereto;
a toggling circuit powered by the conditioned power supply and electrically connected to the radio frequency receiver; and
a relay powered by the conditioned power supply and operable between an on condition and an off condition by electrical connection to the toggling circuit; and

a remote control circuit having:
a portable power supply;
a momentary contact switch operable to electrically connect the portable power supply to a programmable integrated circuit;
a radio frequency transmitter powered by the portable power supply for transmitting a signal matched to the radio frequency receiver;
an electrical connection between the programmable integrated circuit and the radio frequency transmitter for controlling the radio frequency transmitter by the programmable integrated circuit;

the relay having contacts which connect the incoming power supply to an outgoing power supply when in the off condition and disconnecting the incoming power supply from the outgoing power supply when in the on condition.

Preferably, the conditioned power supply is split between a relay power supply for supplying power to the coil of the relay and an electronic component power supply for supplying power to the electronic components in the remainder of the electrical circuit. In such form, the electronic component power supply provides to the radio frequency receiver and the toggling power circuit. Preferably, the toggling power circuit includes two programmable integrated (switching) circuits. In such form, it is preferred that capacitive elements are provided in parallel the power supply to the radio frequency receiver and the programmable integrated (switching) circuits.

The two programmable integrated (switching) circuits comprise a first PIC and a second PIC. The first PIC has an electrical connection to the radio frequency receiver for transmitting data from the radio frequency receiver to the first PIC upon receipt of a predetermined signal by the radio frequency receiver. The first PIC also has an electrical connection to the second PIC for outputting a “go code” from the first PIC to the second PIC. The second PIC has an electrical connection to a relay toggling circuit. Preferably, the relay toggling circuit includes an NPN transistor, the base of which is connected to the second PIC, the collector of which is connected through the coil of the relay and in parallel with a rectifier to the relay power supply.

In such form, the receipt of a matched radio frequency signal causes the circuitry to activate the NPN transistor, thereby connecting the relay power supply through the transistor to ground to open the circuit and put the relay into its on condition to isolate the incoming power supply from the outgoing power supply. It will be seen that circuitry of the present invention is designed to provide a failure mode which facilitates connection of the incoming power supply to the outgoing power supply.

Preferably, the first and second PIC's and the programmable integrated circuit of the remote control circuit are constituted by three identical electronic components programmed for their particular functions within the circuits of the present invention.

### BRIEF DESCRIPTION OF THE DRAWINGS

In order that the invention may be more readily understood and put into practical effect, a preferred embodiment of the present invention will now be described with reference to the following drawings, and wherein:

FIG. 1 is a circuit diagram for a remote control switching unit according to the invention;

FIG. 2 is a circuit diagram for a UHF transmitter for switching the remote control switching unit of FIG. 1; and

FIG. 3 is a circuit diagram illustrating an example of the incorporation of the switching unit of FIG. 1 in a typical single phase installation.

### DETAILED DESCRIPTION OF THE DRAWINGS

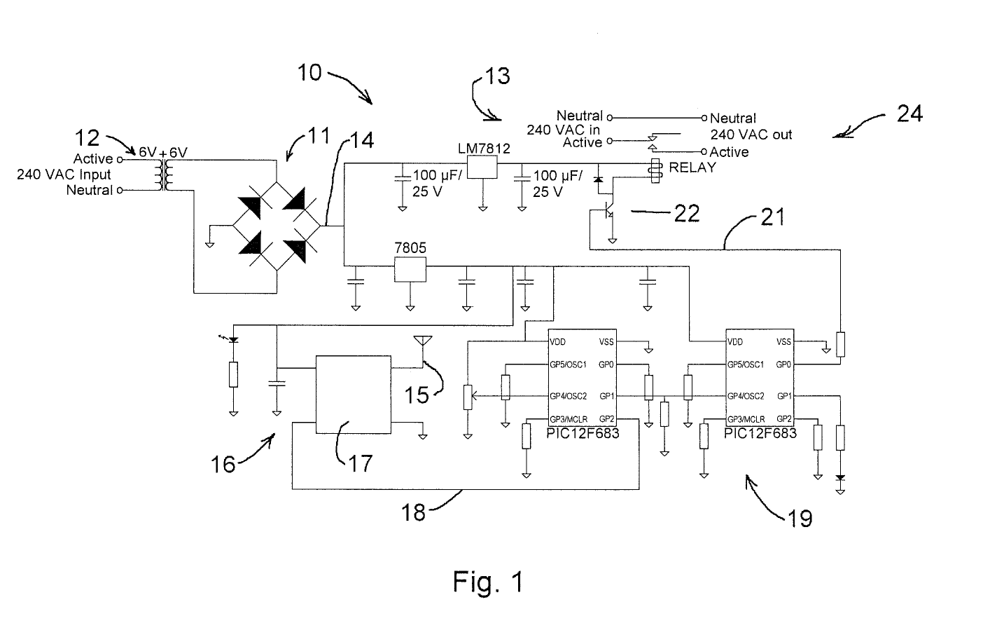

The remote control switching unit 10 having the circuit diagram shown in FIG. 1 includes a transformer rectifier circuit 11 which receives power from a power input 12 in common with a switchable power input 13 through a transformer for lowering the voltage from 240 VAC to 6 VDC (not smoothed). The transformer rectifier circuit supplies power to the remainder of the remote control switching circuit through power conductor 14. The unsmoothed 6 VDC power is conditioned further by capacitors and regulators in electrical connection with the power conductor 14 before being drawn off by other portions of the circuit at about 5 volts.

A signal may be received through a receiving antenna 15 and processed through a signal processing circuit 16 which includes an integrated circuit chip (signal IC chip) 17. If an appropriate signal is received by the antenna and conducted to the signal IC chip, data is output along a data conductor 18 to a data processing circuit 19. The data processing circuit is programmed to toggle a signal via a signal conductor 21 to the base of a toggled transistor 22, the emitter being grounded and the collector being electrically connected to the power conductor through the coil of a relay 23 for toggling on and off power supply from the active terminal of the 240 VAC in at 13 to the 240 VAC out at 24. The emitter of the toggled transistor 22 is connected to ground.

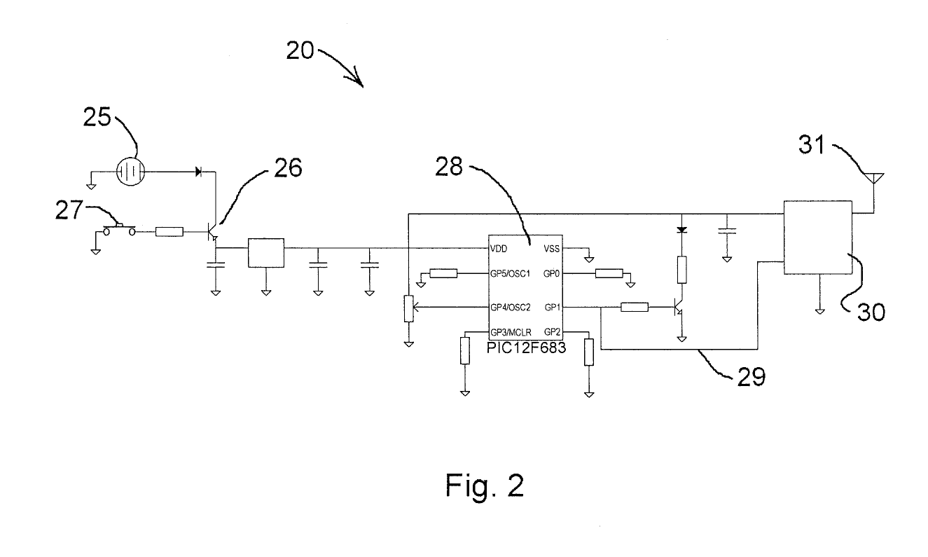

The UHF transmitter 20 having the circuit diagram shown in FIG. 2 is powered by a battery 25 connected to the collector of a transistor 26. The base of the transistor 26 is connected to through a push button 27 to ground. The emitter of the transistor 26 is connected through a regulator to a programmable IC chip 28. The programmable IC chip has a data output connected to a data output line 29 which to provide data to a 433 MHz signal generator 30 in order to produce a signal for transmission from a transmitter antenna 31.

In use, an isolation circuit for the remote control power isolation switch according to the present invention may be interposed in an active power supply conductor for a selected power supply, the circuitry being incorporated into a housing which may be referred to, for convenience, as a power isolation box. The remote control circuit is contained in a housing which may be referred to, for convenience, as a remote control device. The remote control circuitry for the remote control device is matched to the isolation circuit for the power isolation box by programming matching codes or code sets into the programmable integrated circuits.

The momentary contact switch in the remote control circuit is provided with a button for actuation. Pressing the button sufficiently to close the contacts causes activation of the remainder of the remote control circuit, whereupon the radio frequency signal matched to the corresponding receiver to toggle the toggling circuitry to isolate the incoming power supply from the outgoing power supply. Pressing the button a second time causes the toggling circuit to disconnect power to the relay, thereby making contact between the incoming power supply and the outgoing power supply.

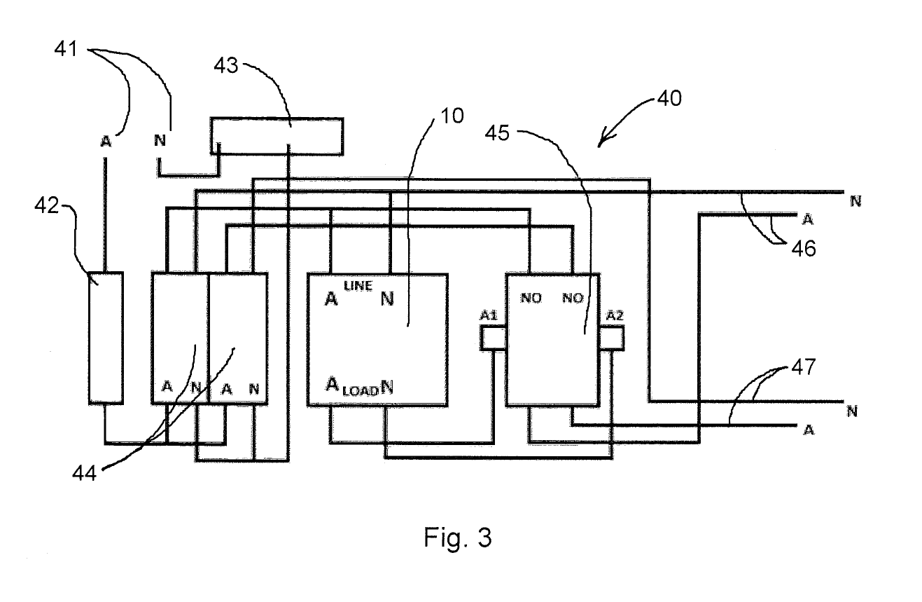

The typical single phase installation 40 illustrated in FIG. 3 includes the remote control switching unit 10 illustrated in FIG. 1 includes a connection to a power supply 41 , The active passing through a main switch 42 and the neutral passing through a neutral connection bus 43. The active connection from the main switch passes through to residual current device circuit breaker combination assemblies 44, each having their respective neutral conductors connected to the neutral bus. The active and neutral conductors proceed from the residual current device assemblies to the remote control switching unit, the line side being at the top of the diagram in FIG. 3 and the load side being at the bottom of the diagram in FIG. 3. Both the active and neutral conductors from the load side of the remote control switching unit are connected to the solenoid coil of a normally open contactor 45, the active and neutral conductors from the residual current device assemblies passing through the contactor to provide to nonessentials supply circuit supplies at 46 and 47.

In a typical single phase installation of the remote control switching unit according to the invention, the line terminals have incoming supply wires thereto. When the remote control switching unit is installed after the circuit breaker and after the safety switch, all non-essential outlets after the unit will be safety switch protected. In the absence of line faults which would otherwise trip the residual current devices (RCD's), with the main switch on, all non-essential outlets will powered until a signal is received from the transmitter, whereupon, the non-essential outlets are isolated at the switchboard.

Fuse or circuit breakers and contactors on the switchboard are selected for the appropriate maximum current rating. For a single non-essential circuit, the non-essential field cable (active and neutral) is connected into the load side of the unit. The incoming active will come from the circuit breaker or safety switch and the incoming neutral for the unit needs to come from the RCD neutral link. For multiple non-essential circuits, the incoming power can be picked up from any terminal on the load side of a RCD protected power circuit breaker. The incoming neutral for the unit needs to come from the RCD neutral link. For such circuits, the active is connected from the load side of the unit to the coil of a N/O contactor. The neutral on the load side of the unit is connected to the coil. The non-essential field cable neutral is connected to the RCD neutral link as the active is running through the contactor. With multiple non-essential circuits, the load side of the non-essential circuit breaker will go to one side of the contactor and the non-essential field cable will go to the other side of the contactor.

In a preferred arrangement, double general purpose outlets (GPO's) are provided with one of the outlets connected to the active and neutral conductors in the normal manner and the other outlets connected to the active and neutral conductors from the remote control switching unit according to the invention. With such an arrangement, the user can choose whether to connect appliances through the normal power supply, notionally for “essential” appliances such as refrigerators and such like, or through the non-essential supply, for “non-essential” appliances, such as televisions and such like. All of the non-essential appliances may be powered down completely by activating the transmitter to open the circuit, cutting off power to all non-essential appliances in one go, thereby saving on power costs not only for standby power, but for appliances which may have been unintentionally left running.

Although the invention has been described with reference to a specific example, it will be appreciated by those skilled in the art that the invention may be embodied in other forms within the broad scope and ambit of the invention as herein set forth and defined by the following claims.

1. A remote control power isolation switch including:
an isolation circuit operatively interposed in an incoming power supply to be remotely switched, the isolation circuit having:
a conditioned power supply powered from the incoming power supply;
a radio frequency receiver powered by the conditioned power supply and having a radio frequency reception antenna electrically connected thereto;
a toggling circuit powered by the conditioned power supply and electrically connected to the radio frequency receiver; and
a relay powered by the conditioned power supply and operable between an on condition and an off condition by electrical connection to the toggling circuit; and
a remote control circuit having:
a portable power supply;
a momentary contact switch operable to electrically connect the portable power supply to a programmable integrated circuit;
a radio frequency transmitter powered by the portable power supply for transmitting a signal matched to the radio frequency receiver;
an electrical connection between the programmable integrated circuit and the radio frequency transmitter for controlling the radio frequency transmitter by the programmable integrated circuit;
the relay having contacts which connect the incoming power supply to an outgoing power supply when in the off condition and disconnecting the incoming power supply from the outgoing power supply when in the on condition.

2. A remote control power isolation switch according to claim 1, wherein the conditioned power supply is split between a relay power supply for supplying power to the coil of the relay and an electronic component power supply for supplying power to the electronic components in the remainder of the electrical circuit.

3. The remote control power isolation switch according to claim 2, wherein, the electronic component power supply provides power to the radio frequency receiver and the toggling circuit.

4. A remote control power isolation switch according to claim 1, wherein the toggling circuit includes two programmable integrated (switching) circuits.

5. The remote control power isolation switch according to claim 4, wherein the two programmable integrated (switching) circuits comprise a first PIC and a second PIC, the first PIC having an electrical connection to the radio frequency receiver for transmitting data from the radio frequency receiver to the first PIC upon receipt of a predetermined signal by the radio frequency receiver and the second PIC having an electrical connection to a relay toggling circuit.

6. The remote control power isolation switch according to claim 5, wherein the first PIC has an electrical connection to the second PIC for outputting a “go code” from the first PIC to the second PIC.

7. The remote control power isolation switch according to claim 6, wherein, the relay toggling circuit includes an NPN transistor, the base of which is connected to the second PIC, the collector of which is connected through the coil of the relay and in parallel with a rectifier to the relay power supply.

8. The remote control power isolation switch according to claim 7, wherein, the first PIC is programmed for receipt of a matched radio frequency signal for causing the circuitry to activate the NPN transistor, thereby connecting the relay power supply through the transistor to ground to open the circuit and put the relay into its on condition to isolate the incoming power supply from the outgoing power supply.

9. The remote control power isolation switch according to claim 5, wherein, the first and second PIC's and the programmable integrated circuit of the remote control circuit are constituted by three identical electronic components programmed for their particular functions within their respective circuits.

10. The remote control power isolation switch according to claim 6, wherein, the first and second PIC's and the programmable integrated circuit of the remote control circuit are constituted by three identical electronic components programmed for their particular functions within their respective circuits.

11. The remote control power isolation switch according to claim 7, wherein, the first and second PIC's and the programmable integrated circuit of the remote control circuit are constituted by three identical electronic components programmed for their particular functions within their respective circuits.

12. The remote control power isolation switch according to claim 8, wherein, the first and second PIC's and the programmable integrated circuit of the remote control circuit are constituted by three identical electronic components programmed for their particular functions within their respective circuits.

13. A remote control power isolation switch according to claim 2, wherein the toggling circuit includes two programmable integrated (switching) circuits.

14. A remote control power isolation switch according to claim 3, wherein the toggling circuit includes two programmable integrated (switching) circuits.
